(19) United States
(12) Patent Application Publication
(10) Pub. No.: US 2008/0018886 A1
(43) Pub. Date: Jan. 24, 2008

(54) OPTICAL ARTICLE HAVING A THERMALLY RESPONSIVE MATERIAL AS AN ANTI-THEFT FEATURE AND A SYSTEM AND METHOD FOR INHIBITING THEFT OF SAME

(75) Inventors: Marc Brian Wisnudel, Clifton Park, NY (US); Ben Purushotam Patel, Niskayuna, NY (US); Andrea Peters, Clifton Park, NY (US); Peng Jiang, Gainesville, FL (US)

Correspondence Address: GENERAL ELECTRIC COMPANY;GLOBAL RESEARCH, PATENT DOCKET RM. BLDG. K1-4A59, NISKAYUNA, NY, 12309, US

(73) Assignee: GENERAL ELECTRIC COMPANY, Schenectady, NY (US)

(21) Appl. No.: 11/567,271

(22) Filed: Dec. 6, 2006

Related U.S. Application Data
(63) Continuation-in-part of application No. 11/286,413, filed on Nov. 21, 2005.
(63) Continuation-in-part of application No. 11/538,451, filed on Oct. 4, 2006.

(51) Int. Cl. G01N 21/00

(52) U.S. Cl. 356/237.1

(57) ABSTRACT

An optical article for being transformed from a pre-activated state of functionality to an activated state of functionality is provided. The optical article includes a thermally responsive optical-state change material, disposed in or proximate to the optical article and being responsive to an external stimulus. The optical-state change material alters irreversibly, the optical article from the pre-activated state of functionality to the activated state of functionality upon interaction with the external stimulus.

The present patent application is a continuation-in-part application from U.S. patent application Ser. No. 11/286413, filed Nov. 21, 2005, and Ser. No. 11/538451, filed Oct. 4, 2006, the disclosures of which are hereby incorporated by reference in their entireties.

### BACKGROUND

The invention relates generally to an optical article. More particularly, the invention relates to an optical article comprising a thermally responsive optical-state change material as part of an anti-theft system, a method and a system for inhibiting the theft of the same.

Shoplifting is a major problem for retail venues and especially for shopping malls, where it is relatively difficult to keep an eye on each customer while they shop or move around in the store. Relatively small objects, such as CDs and DVDs are common targets as they can be easily hidden and carried out of the shops without being noticed. Shops, as well as the entertainment industry, incur monetary losses because of such instances. This problem becomes more severe if the CDs or DVDs are stolen from places like offices due to the potentially sensitive nature of the information contained within the article.

Even though close circuit surveillance cameras may be located at such places, theft still occurs. Consumable products sometimes are equipped with theft-deterrent packaging. For example, clothing, CDs, audiotapes, DVDs and other high-value items are occasionally packaged along with tags that set off an alarm if the item is removed from the store without being purchased. These tags are engineered to detect and alert for shoplifting. For example, tags that are commonly used to secure against shoplifting are the Sensormatic® electronic article surveillance (EAS) tags based on acousto-magnetic technology. RFID tags are also employed to trace the items on store shelves and warehouses. Other theft-deterrent technologies currently used for optical discs include hub caps for DVD cases that lock down the disc and prevent it from being removed from the packaging until it is purchased, and “keepers” that attach to the outside of the DVD case packaging to prevent the opening of the package until it is purchased. In some cases, retailers have resorted to storing merchandise in locked glass display cases. In other stores, the DVD cases on the shelves are empty, and the buyer receives the actual disc only when purchased. Many of these approaches are unappealing because they add an additional inconvenience to the buyer or retailer, or they are not as effective at preventing theft as desired. Optical storage media, in particular, pose an additional problem in that their packaging and the sensor/anti-theft tags may be easily removed.

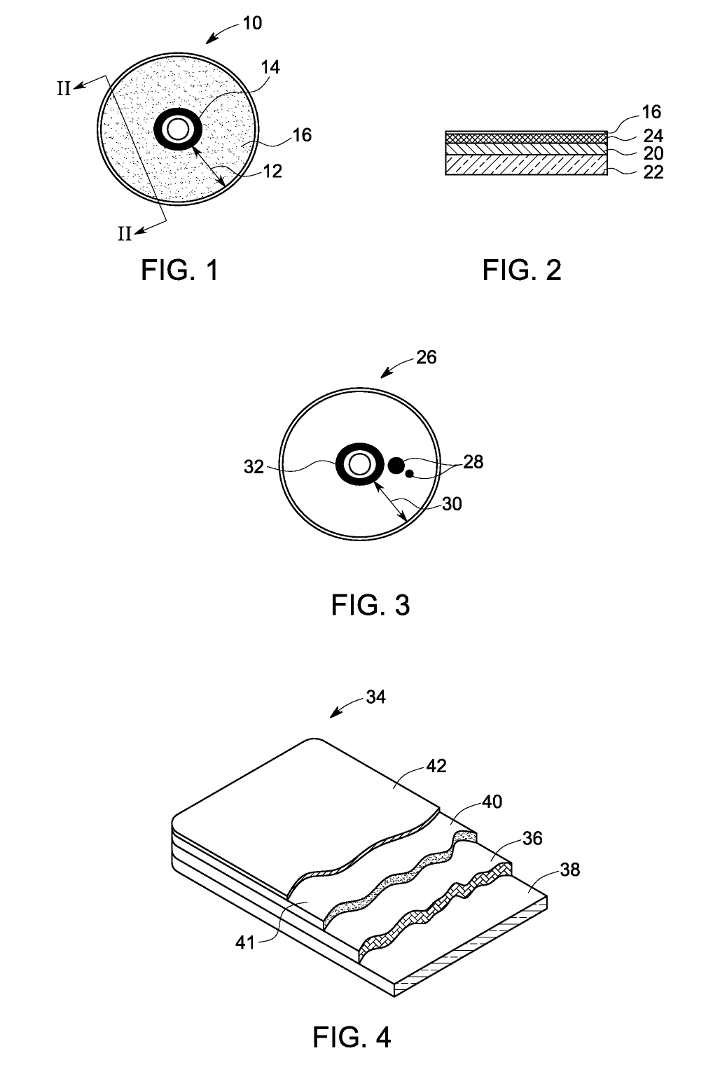

FIG. 1 is a schematic view of an optical storage medium having an optical-state change material disposed thereon and in one of two functionality states in accordance with an exemplary embodiment of the invention.

FIG. 2 is a cross-sectional side view of the optical storage medium of FIG. 1 taken along line II-II.

FIG. 3 is a schematic view of an optical storage medium having an optical-state change material disposed in a discrete area in accordance with an exemplary embodiment of the invention.

FIG. 4 is a partial perspective view of an identification card having a optical-state change material disposed on an optical layer in accordance with an exemplary embodiment of the invention.

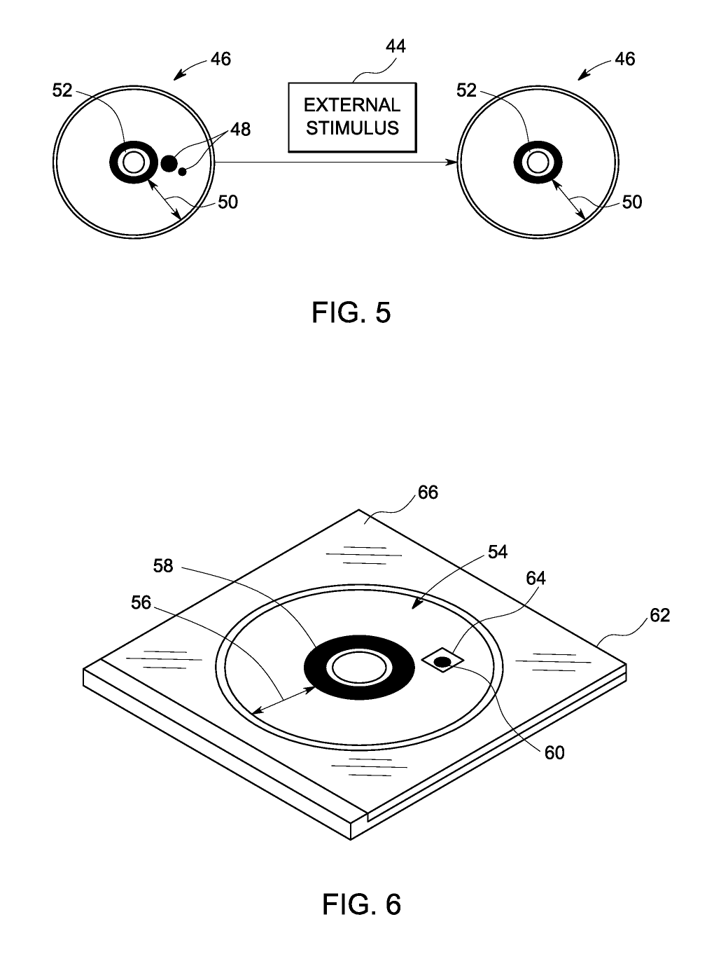

FIG. 5 is a diagrammatical representation of a method for changing a functionality of an optical storage medium in accordance with an exemplary embodiment of the invention.

FIG. 6 is a perspective view of an optical storage medium disposed inside a packaging in accordance with an exemplary embodiment of the invention.

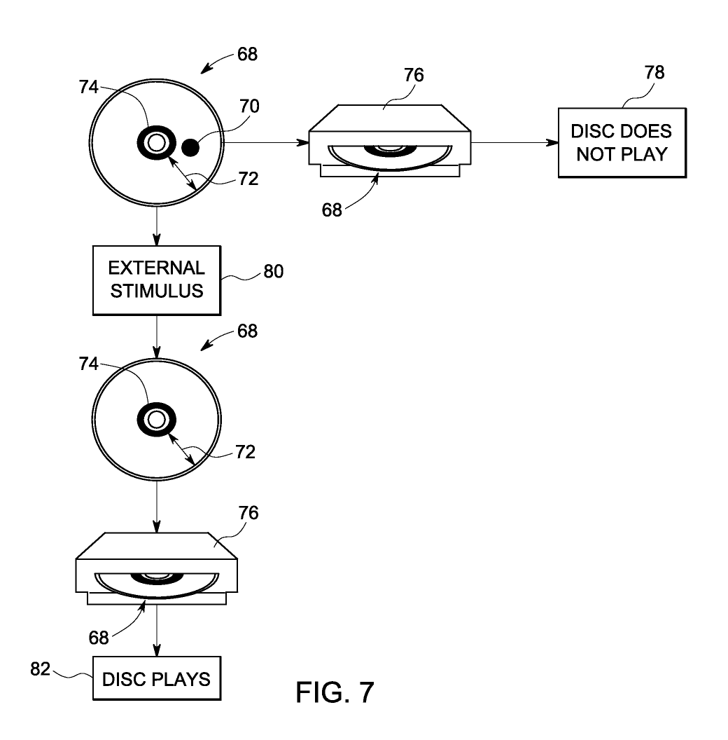

FIG. 7 is a diagrammatical representation of a method for changing a functionality of an optical storage medium in accordance with an exemplary embodiment of the invention.

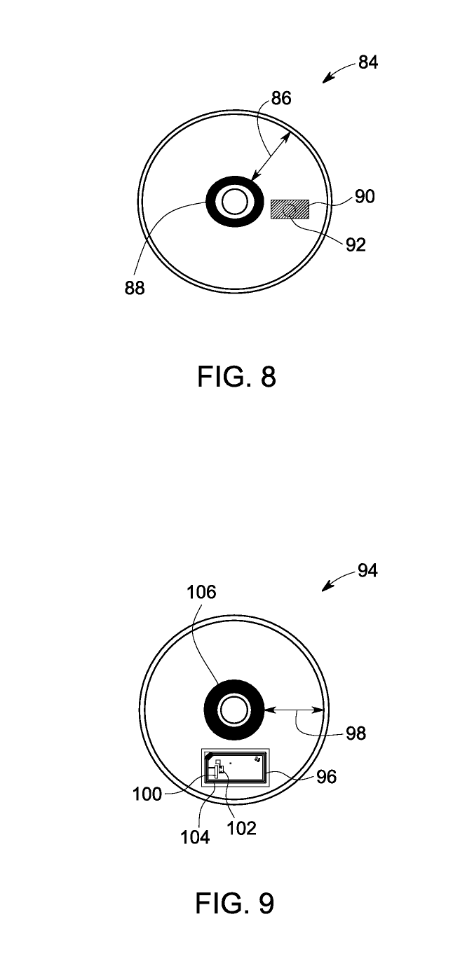

FIG. 8 is a schematic view of an optical storage medium having radio frequency circuitry disposed thereon in accordance with an exemplary embodiment of the invention.

FIG. 9 is a schematic view of an optical storage medium having radio frequency circuitry disposed thereon in accordance with an exemplary embodiment of the invention.

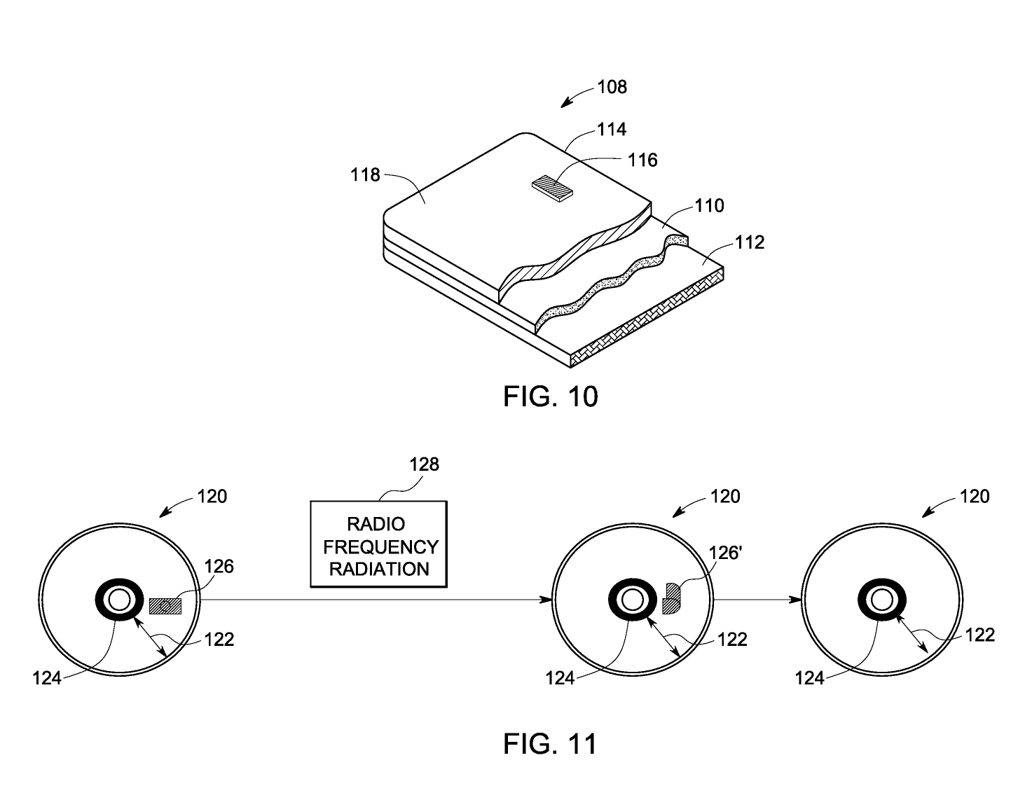

FIG. 10 is a partial perspective view of an identification card having a optical-state change material disposed on an optical layer in accordance with an exemplary embodiment of the invention.

FIG. 11 is a diagrammatical representation of a method for changing a functionality of an optical storage medium in accordance with an exemplary embodiment of the invention.

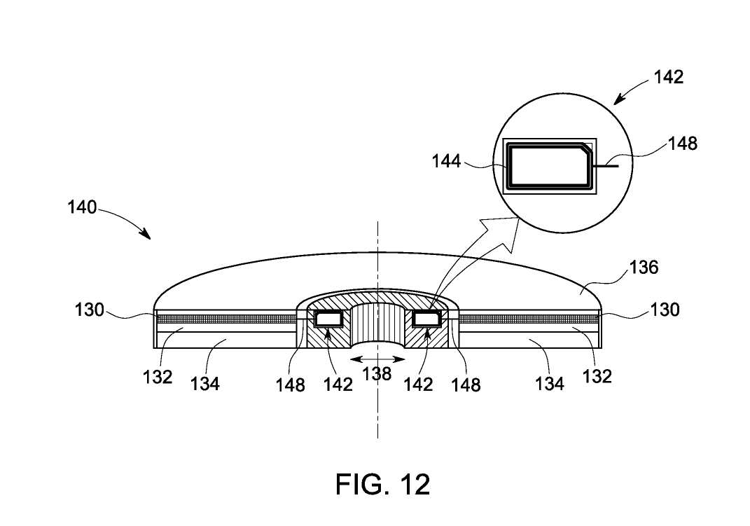

FIG. 12 is a cut away perspective view of an optical storage medium having a layer of thermo chromic material disposed within in accordance with exemplary embodiments of the invention.

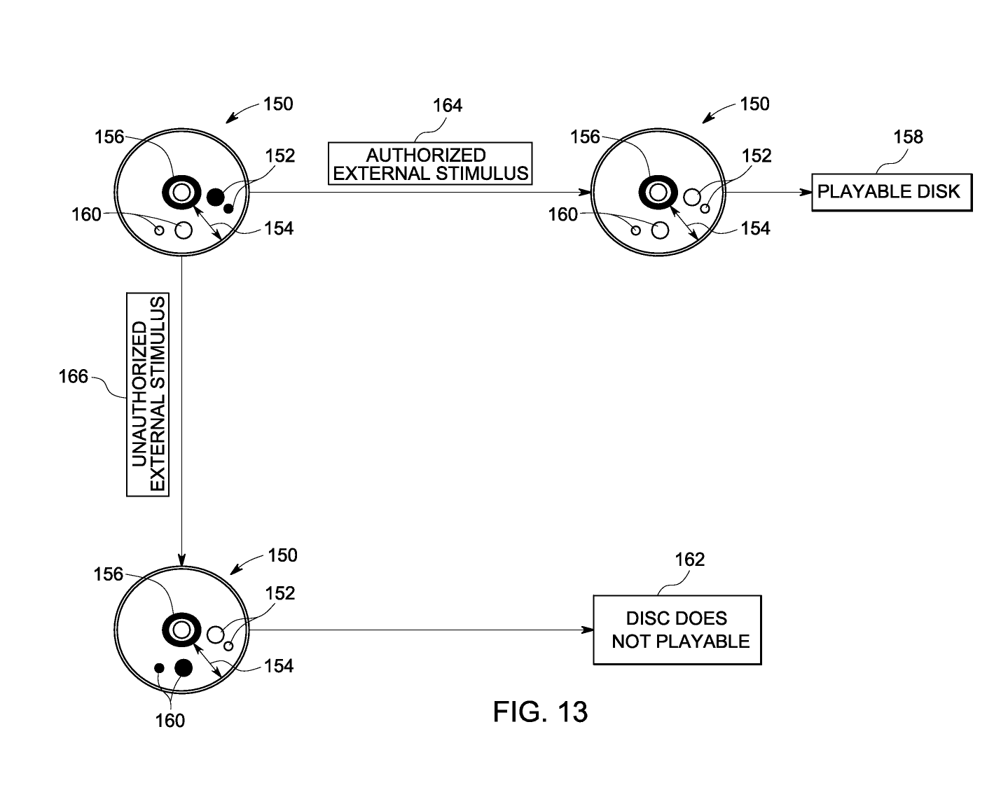

FIG. 13 is a diagrammatical representation of a method for inhibiting unauthorized activation of an optical storage medium in accordance with an exemplary embodiment of the invention.

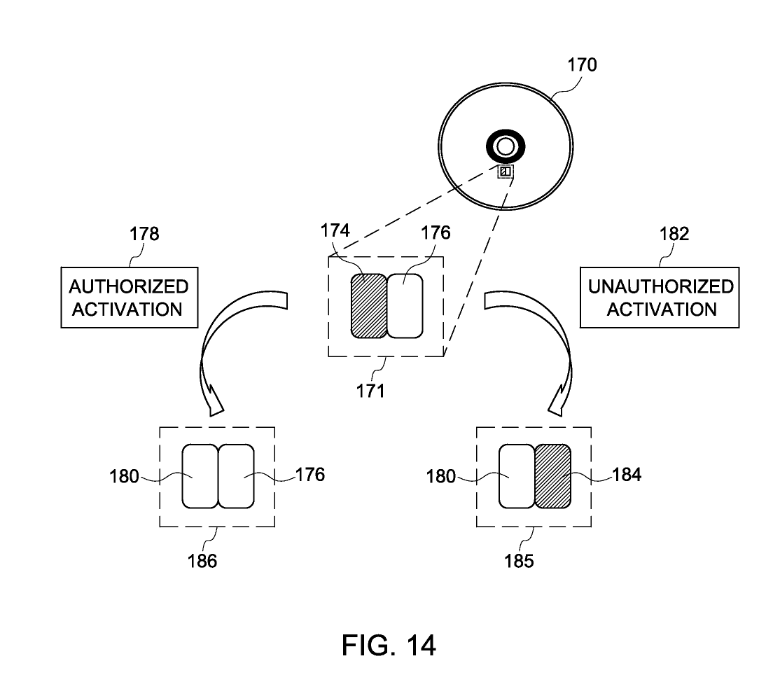

FIG. 14 is a diagrammatical representation of a method for inhibiting unauthorized activation of an optical storage medium with two adjacently placed optical state change material in accordance with an exemplary embodiment of the invention.

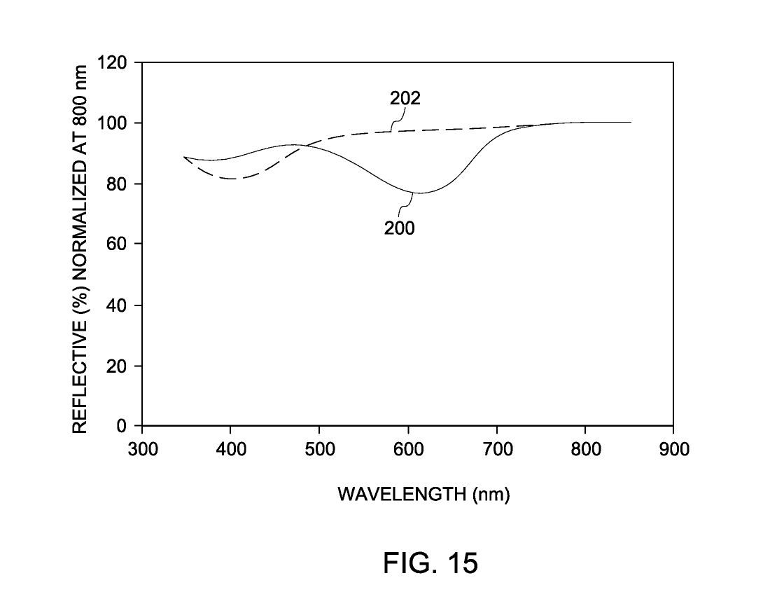

FIG. 15 is graphical representation of a UV-V is spectra showing the percent reflectivity of a screen printed film before (blue) and after (red) heating with a chip resistor.

### SUMMARY

Embodiments of the invention are directed to an optical article comprising a thermally responsive optical-state change material as part of an anti-theft system, a method and a system for inhibiting theft of the same.

In one exemplary embodiment of the invention, an optical article comprising a thermally responsive optical-state change material can be transformed from a “pre-activated state” of functionality to an “activated” state of functionality upon interaction with an external stimulus. The optical article comprises an optical data layer for storing data, and a thermally responsive optical-state change material having an optical absorbance in the range of about 200 nm to about 800 nm, disposed in or on the optical article such that the optical-state change material is in optical communication with the optical data layer. In one embodiment, the optical-state change material may irreversibly alter the optical article from the “pre-activated” state of functionality to the “activated” state of functionality upon interaction with an external stimulus, allowing data from a specific portion of the optical data layer to be read by the incident laser of an optical data reader, only in the “activated” state of functionality.

Another exemplary embodiment is a method for exposing an optical article to an external stimulus, where the optical article includes an optical data layer for storing data and a thermally responsive optical-state change material having an optical absorbance in the range of about 200 nm to about 800 nm disposed in or on the optical article. The optical-state change material is in optical communication with the optical data layer and optical-state change material changes optical properties upon exposure to the external stimulus, which irreversibly converts the optical article from a “pre-activated” state to an “activated” state.

Another exemplary embodiment is a method for exposing an optical article to an external stimulus, where the optical article includes an optical data layer for storing data and one or more thermally responsive optical-state change materials having optical absorbances in the range of about 200 nm to about 800 nm disposed in or on the optical article. The optical-state change material is in optical communication with the optical data layer. Upon exposure to an authorized external stimulus, one or more optical-state change materials change optical properties irreversibly, converting the optical article from a “pre-activated” state of functionality to an “activated” state of functionality. If the same optical article is exposed to an unauthorized external stimulus, one or more optical-state change materials changes optical properties irreversibly, converting the optical article from the “pre-activated” state to a “damaged” state rendering at least a portion of the optical data layer unreadable by the incident laser of an optical data reader.

Another exemplary embodiment is thermal activation system for transforming an optical article from a pre-activated state of functionality to an activated state of functionality, comprising an optical article to be activated; an activation device for applying a thermal stimulus to the optical article to effect a change in optical absorbance of the optical article and thereby activate the optical article; and a communication device for providing an activation signal to the activation device to permit activation of the optical article.

These and other advantages and features will be more readily understood from the following detailed description of preferred embodiments of the invention that is provided in connection with the accompanying drawings.

### DETAILED DESCRIPTION OF EXEMPLARY EMBODIMENTS

Embodiments of the invention relate to an optical article having an anti-theft feature to inhibit theft or unauthorized use of the optical article. As used herein, the term “optical article” refers to an article that includes an optical data layer for storing data. The stored data may be read by, for example, an incident laser of an optical data reader device such as a standard compact disc (CD) or digital versatile disc (DVD) drive, commonly found in most computers and home entertainment systems. The optical data layer may include one or more layers. Furthermore, the optical data layer may be protected by employing an outer coating, which is transparent to the incident laser, and therefore allows the incident laser to pass through the outer coating and reach the optical data layer.

The optical article may be a compact disc (CD), a digital versatile disc (DVD), multi-layered structures, such as DVD-5 or DVD-9, multi-sided structures, such as DVD-10 or DVD-18, a high definition digital versatile disc (HD-DVD), a Blu-ray disc, a near field optical storage disc, a holographic storage medium, or another like volumetric optical storage medium, such as, a multi-photon absorption storage format. As will be described in detail below, if the optical article is taken out of its packaging without being authorized, or if the optical article is attempted to be activated using an unauthorized external stimulus, the anti-theft feature will render at least a portion of the optical data layer of the optical article unreadable by the incident laser of an optical data reader device.

In other embodiments, the optical article may also be an identification card, a passport, a payment card, a driver's license, a personal information card, or any other documents or devices, which employ an optical data layer for data storage. As will be described in detail below, in these embodiments, the anti-theft feature renders the article unreadable by the optical reader until it is legitimately activated prior to being issued to the concerned authority. Hence, if the article is stolen before being issued, the data in the optical data layer is not readable and therefore the article is prevented from any unauthorized use before issuance.

In various embodiments of the invention, the optical article may be transformed from a “pre-activated” state of functionality to an “activated” state of functionality. Conversion from the “pre-activated” state of functionality to the “activated” state of functionality is achieved by the authorized activation of a thermally responsive optical-state change material, which is disposed in or on the optical article, such that the optical-state change material is in optical communication with the optical data layer. The optical state-change material is activated by interacting with one or more external stimuli. In one embodiment, the optical-state change material is capable of irreversibly altering the state of functionality of the optical article. In the “pre-activated” state, at least one portion of the data from the optical data layer is unreadable by the incident laser of an optical data reader device, however, this same portion of data can be read from the optical data layer in the “activated” state of functionality.

As used herein, the term “pre-activated” state of functionality refers to a state of functionality of the optical article where the optical-state change material has not yet been exposed to one or more authorized external stimuli. In one embodiment, the “pre-activated” state comprises at least one optical-state change material which inhibits portions of the optical data layer that are located directly in the optical path of the incident laser from being read by the incident laser of an optical data reader. In another embodiment, at least one optical-state change material is at least partially transparent to the incident laser of an optical data reader, and the data on the optical data layer located directly in the optical path of the laser can be read.

As used herein, the term “activated” state, refers to a state of functionality of the optical article where the optical data layer can be read by the optical data reader as a result of the optical article having been exposed to at least one authorized external stimuli. In one embodiment, the optical-state change material is at least partially transparent to the laser from the optical data reader, and does not inhibit the data located directly in the optical path of the laser from being read. In another embodiment, the optical-state change material is at least partially absorbed by the laser from the optical data reader and prevents the data directly in the optical path of the laser from being read.

The change in the optical properties of the optical-state change material upon authorized activation can occur using at least two approaches. In the first approach, the optical-state change material is at least partially absorbed by the incident laser from an optical data reader in the “pre-activated” state, and the data directly in the optical path of the laser cannot be read. In this instance, the optical article is unplayable. Upon converting the optical article to the “activated” state using an authorized external stimulus, the optical-state change material is at least partially transparent to the incident laser from an optical data reader, the data directly in the optical path of the laser can be read, and the disc is playable. The second approach requires an additional “authoring” component which allows the disc to be playable or unplayable, depending on whether portions of the data on the optical data layer can be read by the incident laser from an optical data reader. In this second approach, the optical-state change material is at least partially transparent to the incident laser from an optical data reader in the “pre-activated” state, and the data directly in the optical path of the laser can be read. In this instance, the optical article is “authored” unplayable. Upon converting the optical article to the “activated” state using an authorized external stimulus, the optical-state change material is at least partially absorbed by the incident laser from an optical data reader, the data directly in the optical path of the laser cannot be read, and the disc is “authored” playable.

As used herein, the term “damaged” state refers to a state of functionality of the optical article where unauthorized activation of one or more optical-state change materials in or on the optical article has occurred. In the “damaged” state at least a portion of the optical data layer cannot be read by the laser of an optical data reader as a result of significant absorbance of the laser by at least a portion of at least one optical-state change material. In contrast to the “activated” state, where all the optical-state change materials are sufficiently transparent to the laser from the optical data reader, in the “damaged” state at least a portion of at least one of the optical-state change materials absorbs at least a portion of the wavelength of the incident laser from the optical data reader and prevents the data directly in the optical path of the laser from being read.

In various embodiments the optical article comprises plurality of optical-state change materials, each located at a unique position proximate to the optical article, designed to function in concert as part of the anti-theft system. In one embodiment, at least two optical-state change materials are in direct physical contact with each other, (i.e., juxtaposed next to each other). Suitable examples of two optical-state change materials in direct physical contact include, but are not limited to, concentric lines, concentric arcs, concentric spots, patterned lines, patterned arcs, patterned spots, lines or arcs which are positioned end-to-end, or any combination thereof. In one embodiment an optical article comprises at least two optical-state change materials, wherein at least one optical-state change material is not transparent to the incident laser of an optical data reader in the “pre-activated” state. If the optical article is converted from the “pre-activated” state to the “damaged” state as a result of unauthorized activation, the optical properties of each of the optical-state change materials are designed to change irreversibly such that at least a portion of at least one of the optical-state change materials absorbs the laser from the optical data reader, and prevents the data directly in the optical path of the laser from being read. For example, in one embodiment the optical article comprises two optical-state change materials, the first optical-state change material having an optical absorbance greater than about 450 nm in the “pre-activated” state, and the second optical-state change material having an optical absorbance less than about 450 nm in the “pre-activated” state. Upon authorized activation, the optical article is converted to the “activated” state where the optical properties of only the first optical-state change material is transformed such that the optical absorbance is less than about 450 nm. Upon unauthorized activation, the optical article is converted to a “damaged” state where the optical absorbance of the first optical-state change material is transformed such that the optical absorbance is less than about 450 nm and the optical absorbance of the second optical-state change material is transformed such that the optical absorbance is greater than about 450 nm

The change in optical properties of the optical-state change material in or on optical article upon exposure to an -external stimulus (e.g., from the activation system), can appear in any manner that results in the optical data reader system receiving a substantial change in the amount of optical reflectivity detected. For example, where the optical-state change material is initially opaque and becomes more transparent upon exposure to an authorized external stimulus, there should be a substantial increase in the amount of light reflected off of the data storage layer and transmitted to the optical reader device. For example, most blue materials typically change (reduce) the amount of reflected incident radiation detected by means of selective absorption at one or more given wavelengths of interest (e.g. 650 nm) corresponding to the type of optical data reader system.

In certain embodiments, the change in the percent optical reflectivity or the percent transmittance of at least one portion of the optical data layer in the “pre-activated state” of functionality and the “activated” state of functionality is at least about 10 percent.

In embodiments where the optical article includes a DVD, the “pre-activated” state of functionality is characterized by an optical reflectivity of at least a portion of the optical article being less than about 45 percent or more preferably less than about 20 percent and even more preferably less than about 10 percent. In these embodiments, the data in the optical data layer of the optical storage medium is not readable in the pre-activated state. It should be appreciated that any portion of the optical article that has an optical reflectivity of less than about 45 percent may not be readable by the optical data reader of a typical DVD player. Furthermore, the activated state is characterized by an optical reflectivity of that same portion of the optical article being more than about 45 percent.

It should be appreciated that there are analogous predetermined values of optical properties for activating different optical articles. For example, the specified (as per ECMA-267) minimum optical reflectivity for DVD-9 (dual layer) media is 18 percent to 30 percent and is dependent upon the layer (0 or 1).

The optical-state change material may render the optical article partially or completely unreadable in the pre-activated state of functionality of the optical article. In the pre-activated state, the optical-state change material may act as a read-inhibit layer by preventing the incident laser of an optical data reader from reaching at least a portion of the optical data layer and reading the data on the optical data layer. For example, the optical-state change material may absorb a major portion of the incident laser, thereby preventing it from reaching the optical data layer to read the data.

Upon interaction with one or more external stimuli, the optical absorbance of the optical-state change material may be altered to change the functionality of the optical article from the pre-activated state to the activated state. For example, in the pre-activated state, the optical-state change material may render the optical article unreadable by absorbing a portion of the wavelength from the incident laser of an optical data reader. However, upon interaction with an external stimulus the optical-state change material becomes transparent to the wavelength of the laser used to read the optical article, thereby making the portion of the optical data layer which is located directly in the optical path of the laser from the optical data reader readable in the activated state.

The optical-state change material may be disposed in or on the optical article. For example, the optical-state change material may be disposed in a discrete area on the optical article, such that at least one spot, at least one line, at least one radial arc, at least one patch, a continuous layer, or a patterned layer that extends across at least a portion of the optical article.

Alternatively, instead of being disposed on the surface of the optical article, the optical-state change material may be disposed inside the structure of the optical article. In optical storage articles, the optical-state change material may be disposed in the substrate on which the optical data layer is disposed. In such an embodiment, the optical-state change material may be mixed with the substrate material of the optical article. In alternate embodiments, the optical-state change material may be disposed between the layers of the optical article, or may be disposed within the layers of the optical article. For example, the optical-state change material may be incorporated in the UV curable adhesive of the bonding (spacer) layer. In an exemplary embodiment, the optical-state change material may be mixed with a polycarbonate to form the substrate for the optical storage medium. As used herein, the term “polycarbonate” refers to polycarbonates incorporating structural units derived from one or more dihydroxy aromatic compounds and may include co-polycarbonates and polyester carbonates. It should be appreciated that these optical-state change materials should be thermally stable to withstand the molding temperatures of the optical article. Also, these optical-state change materials may preferably absorb the wavelength of the laser in one of the activated, or the pre-activated state of the optical article. Upon interaction with external stimulus, the dye present inside the substrate changes color. As a result, the substrate may become transparent to the laser light, thereby facilitating the transmittance of laser light through the substrate and making the optical article readable.

The thermally sensitive optical-state change material may include a material having an optical absorbance in the range of about 200 nm to about 800 nm, which changes optical absorbance in response to a thermal stimulus. For example, the optical-state change material may include one or more of a thermochromic material, a dye material, a thermally responsive compound, a Brønsted acid, a Brønsted base, a pH sensitive compound or any combination thereof.

The term “thermochromic material” is used to describe materials that undergo either a reversible or irreversible thermally induced color change. Suitable examples of a thermochromic material include, but are not limited to, thermochromic polymeric materials, thermochromic organic compounds, thermochromic hydrogels, liquid crystalline materials, leuco dyes, inorganic compounds, organometallic compounds, materials capable of undergoing a thermally initiated sigmatropic bond rearrangement, and thermally reactive adduct materials. For example, suitable examples of thermochromic polymeric materials include, but are not limited to, noncrosslinkable and crosslinkable homopolymers and copolymers doped with commercially available thermochromic dyes commonly known to those skilled in the art. Nonlimiting examples of suitable polymer classes used in thermochromic polymeric materials include polyolefins, polyesters, polyamides, polyacrylates polyvinylchloride, polycarbonates, polysulfones, polysiloxanes, polyetherimides, polyetherketones, and copolymers thereof. In the case of non-crosslinked materials, the thermchromic dye can be added at various stages of polymer processing, including the extrusion stage, however, in the case of crosslinkable materials (e.g. thermosetting plastics such as epoxies and crosslinked acryalte resins), the thermochromic dyes must be added during the production of the crosslinkable material.

In various embodiments, the optical state change material comprises a thermochromic material capable of a thermally induced change in bond connectivity. One example of an optical-state change material capable of undergoing a thermally induced change in bond connectivity is one which comprises a material capable of undergoing a thermally induced sigmatropic bond rearrangement resulting in a change in the optical properties of the thermochromic material. Another representative example of a material capable of undergoing a thermally induced change in bond connectivity, is an optical state change material comprising a thermally reactive adduct material, which undergoes a change in visible absorbance upon thermal degradation of the adduct. Alternatively, the optical state change material may comprise a thermally responsive material which undergoes a change in optical absorbance as a result of a change in the formal oxidation state of the material that may or may not include a change in bond connectivity.

In one embodiment the optical-state change material may comprise one or more of a dye material, sometimes referred to as a leuco dye material (e.g. a dye material whose molecules can acquire two forms, each form possessing a different optical absorbance). For example, suitable examples of dye materials include, but are not limited to, Bromocresol green, Bromocresol purple, Bromophenol blue, Thymolphthalein, Thymol blue, Aniline blue WS, Durazol blue 4R, Durazol blue 8G, Magenta II, Mauveine, Naphthalene blue black, Orcein, Pontamine sky blue 5B, Naphthol green B, Picric acid, Martius yellow, Naphthol yellow S, Alcian yellow, Fast yellow, Metanil yellow, Azo-eosin, Xylidine ponceau, Orange G, Ponceau 6R, Chromotrope 2R, Azophloxine, Lissamine fast yellow, Tartrazine, Amido black 10B, Bismarck brown Y, Congo red, Congo corinth, Trypan blue, Evans blue, Sudan III, Sudan IV, Oil red 0, Sudan black B, Biebrich scarlet, Ponceau S, Woodstain scarlet, Sirius red 4B, Sirius red F3B, Fast red B, Fast blue B, Auramine O, Malachite green, Fast green FCF, Light green SF yellowish, Pararosanilin, Rosanilin, New fuchsin, Hoffman's violet, Methyl violet 2B, Crystal violet, Victoria blue 4R, Methyl green, Ethyl green, Ethyl violet, Acid fuchsin, Water blue I, Methyl blue, Chrome violet CG, Chromoxane cyanin R, Victoria blue R, Victoria blue B, Night blue, Pyronin Y, Pyronin B, Rhodamine B, Fluorescein, Eosin Y ws, Ethyl eosin, Eosin B, Phloxine B, Erythrosin B, Rose bengal, Gallein, Acriflavine, Acridine orange, Primuline, Thioflavine T, Thioflavine S, Safranin O, Neutral red, Azocarmine G, Azocarmine B, Safranin O, Gallocyanin, Gallamine blue, Celestine blue B, Nile blue A, Thionin, Azure C, Azure A, Azure B, Methylene blue, Methylene green, Toluidine blue O, Alizarin, Alizarin red S, Purpurin, Anthracene blue SWR, Alizarin cyanin BBS, Nuclear fast red, Alizarin blue, Luxol fast blue MBS, Alcian blue 8GX, Saffron, Brazilin & Brazilein, Hematoxylin & Hematein, Laccaic acid, Kermes, and Carmine.

In one embodiment, the thermochromic material is a dye material comprising a thermally labile protecting group (e.g. a group which is introduced into the dye material by chemical modification of a functional group in order to change the chemoselectivity of the functional group and to change the optical absorbance of the dye material). Suitable classes of thermally labile protecting groups include acid catalyzed protecting groups and base catalyzed protecting groups commonly known to one skilled in the art of organic synthesis, including but not limited to, protecting groups comprising a carbonyl group, protecting groups comprising a silyl group, protecting groups comprising a sulfonate group, and protecting groups comprising at least 4 carbon atoms (i.e. the tert-butoxycarbonyl group and the fluorenylmethoxycarbonyl group). Additionally, suitable protecting groups are included in references U.S. Pat. No. 6,486,319(B1) and U.S. Pat. No. 6,958,181(B1). Suitable examples of thermally responsive materials include, but are not limited to, inorganic phosphors, semiconductor quantum dots, anti-Stokes shift luminescent compounds, Stokes shift luminescent compounds, inorganic salts, thermally latent Brønsted acids, and any combinations thereof. Thermally latent Brønsted acids include, but are not limited to, salts of Brønsted acids such as salts of trifluoromethane sulfonic acid, and salts of “super acids” (e.g. salts of hexafluoroantimonate). For example, suitable thermally latent Brønsted acids include but are not limited to, alkali metal salts, amine salts, ammonium salts, iodonium salts, salts of hexafluoroantimonate, salts of trifluoromethane sulfonic acid, salts of dinonylnaphthalene disulfonic acid, salts of dinonylnaphthalene sulfonic acid, dodecylbenzene sulfonic acid, salts of p-toluenesulfonic acid, alkyl acid phosphates, phenyl acid phosphates, (4-phenoxyphenyl)diphenylsulfonium trifluoromethanesulfonate, bis(4-t-butylphenyl)iodonium p-toluenesulfonate, (4-t-butylphenyl)diphenlsulfonium triflate, triphenylsulfonium triflate, diphenyliodoniumhexafluorophosphate, ethyl p-toluenesulfonate, dipenyliodonium chloride, 4-octyloxyphenyl phenyl iodonium fluoroantimonate, ethyl benzoate, and any combinations thereof. Samples of suitable thermally latent acids used in the examples described herein (e.g. XC-7231) were obtained from King Industries, Inc. (Norwalk, Conn.)

Alternatively, the optical-state change material could be a pH responsive dye where a change in the acidity or basicity of the optical-state change material results in a change in the optical absorbance of the dye material. This process is also known as “acidichromism” or “halochromism”. The change in the optical absorbance of the dye material could result in converting the optical article from one state of functionality to another. Within the scope of this disclosure the terms “pH” or “change in pH” are used to describe the acidity, basicity, or change in acidity or basicity of the optical-state change material. A decrease in pH is a result of an increase in acidity (or decrease in basicity) and an increase in pH is a result of a decrease in acidity (or increase in basicity). In aqueous systems, pH values less than 7 are classified as acidic and pH values greater than 7 are classified as basic.

In one embodiment, the optical-state change material may include a pH responsive dye, a thermally responsive acid, a thermally responsive base or any combinations thereof. For example, the optical-state change material may contain a pH responsive dye such as bromocresol green or bromocresol purple which can change their maximum optical absorbance from about 600-650 nm at about a pH value greater than about 7 to below 450 nm at pH values less than about 5. Suitable examples of pH responsive dyes include, but are not limited to, those dyes listed in this disclosure.

In various embodiments the optical-state change material comprises at least one component, which is encapsulated inside a temperature sensitive coating material. The temperature sensitive coating material serves to segregate the encapsulated component from additional components of the optical-state change material in the pre-activated state. The temperature sensitive coating material is selected such that it can be melted, dissolved, or otherwise fractured at a particular temperature, thereby freeing the encapsulated component to interact with at least one additional component of the optical-state change material in the activated state. Suitable examples of temperature sensitive coating materials include, but are not limited to, aliphatic waxes, olefin waxes, paraffin waxes, saturated oils, unsaturated oils, and any carbon or silicon based polymeric material with a glass transition temperature below about 70° C. For example, in one embodiment the thermally sensitive optical-state change material comprises a dye material encapsulated inside a temperature sensitive coating material. In another embodiment, the thermally sensitive optical-state change material comprises a Brønsted acid encapsulated inside a temperature sensitive coating material. In yet another embodiment, the thermally sensitive optical-state change material comprises a Brønsted base encapsulated inside a temperature sensitive coating material.

Suitable examples of external stimuli may include a laser, infrared radiation, thermal energy, X-rays, gamma rays, microwaves, visible light, ultraviolet light, ultrasound waves, radio frequency waves, microwaves, electrical energy, chemical energy, magnetic energy, or combinations thereof. The interaction of the external stimulus with the optical article may include continuous, discontinuous, or pulsed forms of the external stimulus.

One or more optical-state change materials may be disposed on the optical article in various forms, such as a discrete portion, a continuous film, or a patterned film. During authorization, the optical-state change material may be heated in a continuous, discontinuous or pulsed form. Sources of heat include, but are not limited to infrared lamps, laser radiation, resistive heating elements or inductive heating elements, which may be in direct contact with the optical-state change material or may radiate or conduct heat to at least a portion of the optical-state change material. to render a change in the optical absorbance of the optical-state change material such that the incident laser may pass through the optical-state change material and reach the optical data layer. For example, when the optical-state change material is employed in the form of a coating, a discrete portion, a pattern, or a continuous layer, the heat may change the color of the optical-state change material to make it transparent to the laser.

In at least one embodiment, the thermally responsive optical-state change material is one part of an anti-theft system designed to prevent the unauthorized use of the optical article, designed to work in combination with additional components of the anti-theft system such as a removable wireless activation tag.

As will be described in detail below, a tag having electrical circuitry may be employed to supply thermal energy to the optical-state change material. In an exemplary embodiment, the tag may be a wirelessly powered flexible tag (WPFT) having electrical circuitry. Examples of electrical circuitry may include radio frequency circuitry, which may be used to interact with the external stimulus to change the external stimulus first into electrical energy, and then ultimately into thermal energy, which then interacts with the optical-state change material to change the functionality of the optical article. The WPFT may be removably coupled to a surface of the optical article using a pressure-sensitive adhesive or by using other coupling mechanisms. Non-limiting examples of coupling mechanisms include static cling, gravity, bracing, sandwiching, mechanical clamping or any other physical means of adhesion. The electrical circuit may be configured to transform the external stimulus first to electrical energy and then to thermal energy. The WPFT may be in direct contact with the material capable of undergoing an optical state change.

Various embodiments of the WPFT described herein allow the wireless transfer of energy from an external stimulus to the material capable of undergoing a optical state change through the WPFT, because the WPFT is configured to act as a “wireless” device. As used herein, the terms “wireless”, “wirelessly”, “wireless powered”, “wirelessly powered” or “wireless activation” all refer to a mechanism of energy transfer in which electromagnetic energy is transported through space (e.g. without the use of any connecting wires or other physical connections) from a remote external stimulus to the WPFT. Non-limiting examples of suitable external stimuli that may be used to interact with the WPFT include laser radiation, infrared radiation, thermal energy, X-rays, gamma rays, microwaves, visible light, ultraviolet light, ultrasound waves, sound waves, radio frequency (RF) waves, electrical energy, chemical energy, magnetic energy, mechanical energy, or combinations thereof. Furthermore, inter-conversion between any of the above listed external stimuli (e.g. conversion of radio frequency waves to electrical energy and/or thermal energy) is also contemplated within the scope of this invention. The interaction of the external stimulus with the WPFT may include continuous, discontinuous, or pulsed forms of the external stimulus. In one embodiment, the external stimulus is radio frequency waves generated from an RF power supply, and wirelessly supplied to the WPFT. The RF power supply may contain a programmable interface that controls the WPFT and optionally receives information back from the WPFT.

As used herein, the term “flexible” is synonymous with the term bendable, and the flexible aspect of a WPFT is analogous to the flexible aspect of other known flexible electronic devices such as flexible organic light emitting diodes, flexible liquid crystal displays, flexible circuit boards, and flexible solar cells. The flexible quality of the WPFT stems from the use of bendable materials within the WPFT, such as thin metal foils, plastics or other polymeric materials.

In various embodiments, the WPFT includes a coupling layer. The coupling layer may either be a single layer or may be a combination of a plurality of sub-layers, which may be collectively termed as the coupling layer. The thickness of the coupling layer may be uniform or may vary from one point to another. For example, the coupling layer may have a variable thickness when the coupling layer is patterned to form one or more recess to dispose electrical circuits therein. In one embodiment the thickness of the coupling layer may be in a range from about 1 micron to about 100,000 microns. In a preferred embodiment, the thickness of the coupling layer is from about 1 micron to about 1000 microns.

The coupling layer may be coupled to the optical article by employing variety of coupling mechanisms to promote attraction forces between the WPFT and the optical article. The coupling mechanisms may include an adhesive mechanism, an electrostatic mechanism, a chemical mechanism, an electrochemical mechanism, a thermal mechanism, a physical mechanism, a cross-linking mechanism, or any combination thereof. Non-limiting examples of suitable coupling mechanisms include static cling, gravity, bracing, sandwiching, mechanical fixing, clamping, chemical adhesion, or any other physical means of adhesion that affix the WPFT to the optical article. In some embodiments the coupling mechanism may enable reuse of the WPFT. In other words, the WPFT may be coupled and decoupled from the optical article more than once, as desired, and therefore it is envisioned that the WPFT could be a disposable device. Embodiments relating to the reuse of the WPFT with the same or different optical articles are described in more detail below with regard to the adhesive components of the coupling layer. Alternatively, the WPFT may be configured to function as an irremovable device once affixed to an optical article. The attraction forces produced by the above mentioned coupling mechanisms may or may not be uniform at the interface between the coupling layer and the optical article. For example, the attraction forces may be weaker at the edges of the WPFT to facilitate removal (e.g. peeling off) of the WPFT once the predetermined and desired electrical and/or thermal response has been induced in the optical article.

The coupling layer may include a plurality of individual sub-layers, which form a stack generally referred to as the coupling layer. In one embodiment, at least one sub-layer of the coupling layer comprises an adhesive component. Non-limiting examples of suitable adhesive components include pressure sensitive adhesives, epoxy based adhesives, thermoset adhesives, acrylate based adhesives, silicone-based adhesives, and elastomer based adhesives or any combination thereof. As use herein, the term “pressure-sensitive adhesive” includes all polymeric adhesive materials with a glass transition temperature (Tg) below about 50° C. In embodiments comprising an adhesive component, the coupling layer includes a first coupling surface with a first tack strength, and a second coupling surface with a second tack strength. As used herein, the term “tack strength” refers to “stickiness” of the coupling layer, and is a measurement of the strength of adhesion, typically measured in units of pounds-force per inch. The first surface of the coupling layer is typically coupled to the optical article to define a first region. The second surface of the coupling layer may be coupled to other components of the WPFT, such as an electrical circuit layer or an optional backing layer, to define a second region. In at least one embodiment, both the first and second surfaces of the coupling layer are coupled to the optical article.

In embodiments where the coupling layer comprises an adhesive component, one aspect of the coupling layer is the ability of the WPFT to be decoupled from an optical article such that the WPFT undergoes a “clean adhesive failure” at the first region between the coupling layer and the optical article. As used herein, the term “clean adhesive failure” is defined as the removal of the WPFT from the optical article such that no significant residue of the coupling layer is left behind on the optical article. As used herein, and with respect to the term “clean adhesive failure”, the term “significant” refers to a quantity that affects or interferes with the usability of the optical article. For example, as will be described in detail below, in the case where the optical article is a DVD, “clean adhesive failure” of the WPFT from the surface of the of the DVD means that the quantity of residue of the coupling layer which might be left behind on the surface of the DVD, including residue which is not visible to the naked eye or touch, is sufficiently small in quantity as to not interfere with the readability of the DVD in a standard DVD reader.

The WPFT further comprises electrical circuitry, including at least one electrode and/or at least one heating element. As used herein, the electrical circuitry includes, but is not limited to, a transistor, a thermocouple, a light-emitting diode, a strain gauge, a sound detecting element, an antenna, a transistor, a diode, a rectifier, a logic chip, a radio frequency identification chip, a capacitor, an integrated circuit, an electrical receiver, a photocell, a rectifier, a resistor, a surface mount resistor, a chip resistor, an electrode, a surface mount light emitting diode (LED) or any combination or multiple thereof. In one embodiment, the WPFT may also contain an integrated circuit with a programmable unique identification number as is used in RFID tags. Various components of the electrical circuitry may be patterned onto the WPFT by a variety of microelectronic techniques including, but not limited to, lithography, sputtering, screen printing, ink-jet printing, or any other routine patterning method which is known to one skilled in the art of microelectronics. Alternatively, various components of the electrical circuitry may be added to the WPFT by physical means, such as “pick-and-place” or other robotic techniques commonly used in the microelectronics industry. In an exemplary embodiment, the electrical circuitry comprises a radio frequency circuitry, including a radio frequency antenna coupled to various additional circuitry components. The radio frequency circuitry is in electrical communication with at least one electrode and/or at least one heating element contained within the WPFT. The electrical circuitry may be disposed on a sub-layer of the coupling, or in embodiments where the WPFT employs an optional backing layer the electrical circuitry may be coupled to the backing layer.

In embodiments where the WPFT comprises at least one heating element, the heating element may be fabricated from a material with sufficiently high surface ohmic resistance. High ohmic resistance can be achieved either by controlling the dimensionality of the heating element (e.g. making the heating element very thin), or as a result of the intrinsic electrical resistivity of the material. For example, materials with a surface ohmic resistivity greater than about 5 ohms/square are suitable, and materials with an ohmic resistivity greater than about 15 ohms/square are especially preferred. Non-limiting examples of suitable heating element materials include titanium, copper, nickel, gold, tantalum-nitride, aluminum, molybdenum, titanium-tungsten, chrome, platinum, nichrome, indium tin oxide (ITO) and any combinations thereof. Embodiments where the heating element is encased in a ceramic or glass housing (e.g. chip resistors) are also contemplated within the scope of this invention. It should be noted that in embodiments comprising a heating element, direct contact between the heating element and the material capable of undergoing a morphological transformation is not strictly required for the WPFT to induce the desired thermal response in the material capable of undergoing a morphological transformation; however, it is preferred.

The WPFT may be in operative association with one or more devices, such that the devices may receive energy from the external stimulus in one form and transfer it to the WPFT. The energy is then transferred from the WPFT to the optical article to which the WPFT is coupled to change the state of functionality of the optical article. For example, the WPFT may react with an external stimulus, such as radio frequency waves, and through operative association with the radio frequency circuitry within the WPFT, convert the radio frequency waves into electrical energy and/or thermal energy. The converted electrical energy may then be transferred to the optical article to change the functionality of the optical article from the pre-activated state to the activated state. In the case where the energy from the external stimulus is converted to an electrical response within the WPFT, current in the range from about 1 microampere to about 1 ampere and voltages in the range from about 1 millivolt to about 100 volts are possible at specific regions between the WPFT and the optical article. In the case where the energy from the external stimulus is converted to a thermal energy within the WPFT, a temperature increase in the range of about 10° C. to about 200° C. is possible at specific regions of the interface between the WPFT and the optical article.

Additionally, the WPFT may contain a feedback loop. The feedback loop may be configured to communicate with the source of the external stimulus that is at a remote location and provide inputs to regulate the exposure of WPFT to the external stimulus. For example, the feedback loop may be configured to maintain the temperature of the optical article within a predetermined temperature range by controlling the input of external stimulus to the WPFT. Accordingly, when the temperature of the optical article exceeds the predetermined temperature range, the feedback loop communicates with the source of the external stimulus to reduce the amount of external stimulus interacting with the WPFT, thereby controlling the temperature of the optical article. In another example, the feedback loop may be employed to maintain the records for the usage of the devices. When employed to authorize an article, the WPFT may be used to maintain records and/or to maintain inventory.

In some embodiments, the WPFT comprises an integrated logic chip within its electrical circuitry, which is in wireless communication with an external authorization device that controls the output response of the WPFT through a feedback loop. The function of the integrated logic chip is to act as an internal “on/off” switch within the WPFT, such that the WPFT becomes operationally active (i.e., generates an electrical and/or thermal response in the optical article to which it is affixed) only once it has been authorized to do so by an external authorization device. This feature of the WPFT is useful in applications where there is a desire to control the function of the WPFT, such as anti-theft applications.

In one embodiment, energy may be delivered to the WPFT by inductive coupling of low frequency radio waves with a wavelength much longer than the largest dimension of the WPFT. It should be appreciated that RF signals with long wavelengths are preferred for such applications, because they are easier to shield than signals with shorter wavelengths. In one embodiment, the transmission means may be identified as an air-core radio frequency transformer. For such transformers to efficiently transfer RF power, they must be matched to the impedance of the external source and load impedance. In one embodiment, the source of external stimulus is the external RF power generator and the load is the heating element(s) and/or electrode(s) to be operated on the WPFT. Impedances of 50 ohms are typical for the source, but impedances may range from a few ohms up to a few hundred ohms for the load(s). As will be appreciated, any impedance matching technique well known in the art can be used to match the transformer, but circuits that require only capacitors and the native inductance of the transformer coils are strongly preferred for their small size.

In one embodiment the energy transferred to the WPFT by inductive coupling is radio frequency alternating current whose frequency may range from hundreds of kHz to hundreds of MHz. This RF AC may be used directly for some embodiments of the WPFT, specifically those embodiments comprising at least one heating element. For such RF loads, the signal should be transmitted between the transformer secondary coil on the WPFT and the load by a RF transmission line to minimize radiation and to maintain the proper load impedance. If the load requires DC rather than AC, then a rectifier and possibly other electronic circuitry described above would be necessary to convert the energy into the required form.

Another exemplary embodiment is a method for exposing an optical article to an external stimulus, where the optical article includes an optical data layer for storing data and one or more thermally responsive optical-state change materials having optical absorbances in the range of about 200 nm to about 800 nm disposed in or on the optical article. The optical-state change material is in optical communication with the optical data layer. Upon exposure to an authorized external stimulus, the external stimulus is directed towards predetermined areas of the optical article having the optical-state change material resulting in change of optical absorbance. This change irreversibly converts the optical article from a pre-activated state to an activated state. The same optical article could be made irreversibly unreadable upon unauthorized attempts to activate the optical article. For example when the optical article is subjected to authorized activation stimulus, the stimulus is directed to specific regions of optical article disposed with one optical-state change material, which could change from an optically opaque to an optically transparent state, thereby allowing the incident laser to read the data from the optical data layer. If unauthorized activation is attempted, for example, by direct heating of the optical article, a second optical-state change material disposed on the optical article could change from optically transparent in the pre-activated state to optically opaque thereby producing a damaged state which prevents access to the data from the data layer of the optical article

Another exemplary embodiment is thermal activation system for transforming an optical article from a pre-activated state of functionality to an activated state of functionality, comprising an optical article to be activated; an activation device for applying a thermal stimulus to the optical article to effect a change in optical absorbance of the optical article and thereby activate the optical article; and a communication device for providing an activation signal to the activation device to permit activation of the optical article.

Another exemplary embodiment is thermal activation system for transforming an optical article from a pre-activated state of functionality to an activated state of functionality, comprising an optical article to be activated; the optical article comprise a thermally responsive optical-state change material having optical absorbance in the range of 200 nm to 800 nm., an activation device which could comprises a wirelessly powered flexible tag, operatively coupled to the optical article for applying a thermal stimulus to the optical article to effect a change in optical absorbance of the optical article and thereby activate the optical article; and a communication device such as RFID reader disposed outside optical article and configured to communicatively interact with the activation device for providing an activation signal to the activation device to permit activation of the optical article.

In one embodiment the optical state change material of the thermal activation system could be a thermochromic material, dye, thermally sensitive compound, or combinations thereof.

Another embodiment is a thermal activation system, the said tag comprise a radio frequency circuitry, a thermocouple, a light-emitting diode, a strain gauge, a sound detecting element, a diode, an antenna, a dipole, an electrical receiver, a photocell, a resistor, a capacitor, a rectifier, an integrated circuit, a surface mount resistor, a chip resistor, an electrode, a heating element, or any combination or multiple thereof.

In an exemplary embodiment the external stimulus of the thermal activation system comprises a laser, thermal energy, electromagnetic radiation, gamma rays, acoustic waves, electrical energy, chemical energy, magnetic energy, mechanical energy, radio frequency waves, ultraviolet radiation or combinations thereof.

In another embodiment the optical article of the thermal activation system comprises one of a CD, a DVD, a HD-DVD, a blu-ray disc, a near field optical storage disc, a holographic storage medium, an identification card, a passport, a payment card, a driving license, or a personal information card.

Referring now to FIG. 1, the optical storage medium 10 includes a data storage region 12 and an inner hub 14. The data storage region 12 includes an optical data layer 20 (FIG. 2), which stores the data, whereas the inner hub 14 is the non-data storage region of the optical storage medium 10. The optical storage medium 10 has an optical-state change material disposed on the data storage region 12 in the form of a film 16 in the pre-activated state of the optical storage medium 10. The optical-state change material may interact with an external stimulus, such as thermal energy from a heater operatively coupled to the optical article. The optical storage medium 10 upon interaction with the external stimulus undergoes an optical state change, whereby the optical absorbance of the optical-state change material is altered, thereby changing the state of functionality of the optical storage medium 10. For example, in the pre-activated state of the optical storage medium 10, the optical-state change material of the film 16 may be opaque to the incident laser that is used to read the optical storage medium 10. That is, in the pre-activated state the optical-state change material may inhibit the incident laser from reaching the optical data layer 20, whereas after interacting with the external stimulus the optical-state change material may become transparent to the wavelength of the incident laser. As noted above, this change in the optical state may be caused by chemical changes within the optical-state change material, which are caused by exposure to the external stimulus. The film 16 may cover at least a portion of the optical storage medium 16. In the pre-activated state, the optical storage medium 16 may be unplayable or unreadable at least in the portions where the film 16 is disposed. In other words, the optical storage medium 16 has a reflectivity of less than about 45 percent, or preferably less than about 20 percent, or more preferably less than 10 percent in the portions where the film 16 is disposed.

FIG. 2 illustrates a cross-sectional side view of the optical storage medium 10 of FIG. 1. In a simplified illustration of the optical storage medium 10, the optical storage medium 10 includes an optical data layer 20 disposed on a substrate 22. The substrate 22 may include a polycarbonate material. The substrate 22 may include a optical-state change material, such as the optical-state change material of the film 16. The optical data layer 20 is protected by a capping layer 24. It should be appreciated that the capping layer 24 is transparent to the wavelength of the incident laser, which is used to read the data stored in the optical article 10. The capping layer 24 may prevent the optical data layer from exposure to environmental elements, such as air, oxygen, moisture, which may react with the optical data layer and cause any undesired changes, such as oxidation of the optical data layer. Also, the capping layer 24 may prevent mechanical damages to the surface of the optical data layer 20. For example, the capping layer may be scratch resistant. Further, the optical storage medium 10 includes the film 16 of the optical-state change material, which is disposed on the capping layer 24.

FIG. 3 illustrates an optical storage medium 26 having an optical-state change material disposed thereon in discrete portions 28 in the pre-activated state of the optical storage medium 26. The portions 28 are disposed in the data storage region 30 surrounding the inner hub 32. The optical storage medium 26 may have an optical reflectivity of less than 45 percent in these portions 28. Therefore, the optical storage medium 26 may not be readable in these portions 28. In some embodiments, fewer than all of the discrete portions 28 may include optical-state change material. In these embodiments, the portions having the optical-state change material are made to interact with the external stimulus to change the state of functionality of the optical storage medium 26.

FIG. 4 illustrates a simplified structure of an optical article, such as an identification (ID) card 34. As with the optical storage media 10 and 26, the ID card 34 includes an optical data layer 36 for storing data. The ID card 34 further includes a substrate 38 on which the optical data layer 36 is disposed. The substrate 38 may include a polycarbonate material. In an exemplary embodiment, the substrate 38 may include the optical-state change material that may change an optical property upon interaction with the external stimulus, thereby changing the state of functionality of the card 34. The optical data layer 36 is protected by a capping layer 40. As with the substrate 38, the capping layer 40 may also include a polycarbonate material. As noted above with regard to the capping layer 24, the capping layer 40 may be used to protect the optical data layer 36 from chemical and/or mechanical damages. The ID card 34 includes a optical-state change material disposed on the surface 41 of the capping layer 40 in the form of a film 42. In the pre-activated state, the film 42 may prohibit the incident laser from reaching to the optical data layer 36 and reading the data stored therein. However, after interaction with the external stimulus, the film 42 may allow an incident laser to pass through and reach the optical data layer 36, thereby allowing the reader to read the data stored in the optical data layer 36 of the card 34. The ID card 34 may be exposed to the external stimulus before issuing the ID card 34 to the concerned authority, thereby rendering the data in the optical data layer 36 readable by the incident laser. By protecting the data in this manner before issuance of the ID card 34 to the concerned authority, the undesirable use of the card may be prevented in the event the card is stolen from the store where the card was stored prior to issuance. The film 42 may be disposed in different forms on the surface of the capping layer 40. For example, the film 42 may extend across a portion of the capping layer 40, or may form a patterned layer extending across a portion of the capping layer 40, or may form a continuous film, such as film 42, on the capping layer 40.

As described with regard to FIGS. 1-4, the optical-state change material renders the optical article completely or partially unreadable in the pre-activated state of the functionality by changing the reflectivity of the optical article at certain locations. In the activated state of functionality of the optical article, the properties of the optical-state change material are changed from those in the pre-activated state by interacting the optical article with the external stimulus, as will be described below. Therefore, the optical article is ineffective in the pre-activated state.

FIG. 5 illustrates a method of changing the state of functionality of an optical article, such as an optical storage medium 46. Although the illustrated embodiment of FIG. 5 is represented with regard to the optical storage medium 46, the method may be employed to change the functionality of other optical articles, such as an ID card, a payment card, a personal information card, and the like. As illustrated, the external stimulus 44 interacts with the optical-state change material disposed in discrete portions 48 of the optical storage medium 46. The external stimulus 44 may be, for example, a laser, infrared radiation, a thermal energy, infrared rays, X-rays, gamma rays, microwaves, visible light, ultraviolet light, ultrasound waves, radio frequency waves, microwaves, electrical energy, chemical energy, magnetic energy, mechanical energy, or combinations thereof. The optical storage medium 46 includes a data storage region 50 and an inner hub 52.

The optical absorbance of the optical-state change materials are altered upon interaction with the external stimulus 44, thereby increasing the optical reflectivity of the optical article for the incident laser in the portions 48, to make the optical storage medium 46 transparent to the incident laser in the portions 48.

FIG. 6 illustrates an optical article, such as an optical storage medium 54, having a data storage region 56 and an inner hub 58. The optical storage medium 54 includes a optical-state change material disposed in discrete portions 60 on the optical storage medium 54. The optical storage medium 54 is stored inside a packaging 62. The packaging 62 may direct an external stimulus towards the portion 60 through a window 64 that is aligned with at least a portion of the optical-state change material. In the illustrated embodiment, the rest of the area 66 of the packaging 62, other than the window 64, may not be transparent to the external stimulus, and therefore may not participate in directing the external stimulus 44 from outside the packaging 62 toward the portions 60.

FIG. 7 illustrates a method of changing a functionality of an optical article, such as optical storage medium 68. The method may be applied for other optical articles, such as an ID card, a payment card, a personal information card, and the like. As illustrated, the optical storage medium 68 includes a data storage region 72 having a optical-state change material disposed in discrete portions 70. The optical storage medium 68 also has an inner hub 74. When inserted in an optical reader 76 prior to directing an external stimulus to it (pre-activated state), the optical storage medium 68 does not play, that is, the data in the optical data layer (not shown) of the optical storage medium 68 is unreadable (block 78). However, when interacted with an external stimulus 80, the optical-state change material alters the functionality of the optical storage medium 68 (activated state) as described above and renders it readable by the reader 76 (block 82).

The source for external stimulus may be built in the bar code reader, a radio frequency identification reader, an electronic surveillance article reader, like an acousto-magnetic tag detector or deactivator, such that when the optical article or the packaging having the optical article is swiped through the bar code reader, the optical-state change material is allowed to interact with the external stimulus and the state of the optical article is converted to the activated state. Furthermore, the source of the external stimulus may also be integrated with a hand-held wand or computer controlled light boxes at the aisles. It is desirable to have light sources that have a power and/or wavelength of the light which is not commonly available, specifically to defaulting users, such as shoplifters or thieves.

Additionally, the verification of the activation may be conducted on the optical article. The verification may be desirable either to: 1) identify the defaulting users, or 2) to confirm that the optical article was accurately activated at the first point of interaction, such as a point-of-sale. In some embodiments the verification may be conducted at the second location, such as the exit point of the storage location in office premises, a shop, or a store, that is to say, the activation of the optical article may be conducted just before the user leaves the premises of the shop or mall. In these embodiments, the security system installed at the exit locations may send out signals indicating whether or not the optical article is activated. Furthermore, a device may be installed in the security system, such that the device may interact with the optical-state change material in the optical article and make it permanently unreadable if the optical article was carried out without being activated.

Another exemplary embodiment of invention comprises a thermal activation system for transforming an optical article from a pre-activated state of functionality to an activated state of functionality. The thermal activation system comprises a optical article to be activated; an activation device for applying a thermal stimulus to the optical article to effect a change in optical absorbance of the optical article and thereby activate the optical article; and a communication device for providing an activation signal to the activation device to permit activation of the optical article.

As will be described in detail below, the material of the activation element is a multicomponent structure having one or more devices, such that the devices may receive energy from the external stimulus in one form and convert it into another form. The converted form of energy is then utilized by the activation element to interact with the optical-state change material to change the state of functionality of the optical article. For example, the optical-state change material may be in operative association with a multicomponent structure which could comprise a radio frequency (RF) circuitry, coupled to heater and which may react with an external stimulus, such as radio frequency waves, or microwaves, and convert it into thermal energy. This thermal energy may then be utilized by the optical-state material to change the functionality of the optical article from the pre-activated state to the activated state, as will be described in detail below with regard to FIGS. 8-10.

FIG. 8 illustrates an optical article, such as an optical storage medium 84. The optical storage medium 84 includes a data storage region 86 and a non-data storage region or inner hub 88. The optical storage medium 84 may be transformed from a pre-activated state to an activated state of functionality. The RF circuitry 90 may interact with RF radiation to generate thermal energy. As illustrated, the RF circuitry 90 may be located either on the data storage part 86 as shown or in the inner hub 88 of the optical storage medium 84. The optical storage medium 84 includes a optical-state change material 92 coupled to and in operative association with the RF circuitry 90. The optical-state change material 92 may be in the form of a layer. The layer may be continuous or patterned, or may be disposed in a discrete portion of the optical article. Furthermore, the optical-state change material 92 may include a material that is responsive to the thermal energy produced by the RF circuitry 90. The optical-state change material 92 may include thermochromic material, organic dye, thermally sensitive inorganic compound, or combinations thereof.

In some embodiments, the RF circuitry 90 may include different mechanisms for converting the RF radiation into thermal energy. For example, the RF circuitry 90 may include one or more micro-heaters, heater chips, resistors, capacitors, or coils. Furthermore, the RF circuitry 90 may include a programmable logic chip, such as in a radio frequency identification (RFID) tag, as will be described with regard to FIG. 10. Upon exposure to the appropriate RF radiation, the RF circuitry 90 employing, for example, a heater chip, is energized and converts the RF radiation into thermal energy. This conversion of RF energy into thermal energy creates a temperature spike of about 25° C. to 200° C. and locally heats the area of the RF circuitry 90. The optical-state change material disposed proximate to and coupled to the RF circuitry 90 interacts with this thermal energy, thereby changing an optical property. For example, due to the temperature spike, the dye layer on the optical article 84 may become transparent to the incident laser.

As illustrated in FIG. 9, an optical storage medium 94 includes a radio frequency identification (RFID) tag 96 disposed on the data storage region 98 of the optical storage medium 94. The RFID tag 96 in its basic form includes an integrated circuit (IC) operatively coupled to an antenna 104, which is a small coil of wires. The data is stored in the IC, sent to the antenna 104, and transmitted to a reader. The RFID tag 96 also includes a program logic chip 102 and a capacitor 100. In some embodiments, the antenna 104 may be disposed in the inner hub 106 of the optical storage medium 94. The optical storage medium 94 includes a layer (not shown) of a optical-state change material that is disposed between the RFID tag 96 and the optical storage medium 94. The layer of the optical-state change material may render an optical state change when subjected to thermal energy produced by the RFID tag 96, thus altering the state of functionality of the optical storage medium 94.

As with FIG. 6, the optical articles 84 or 94 may also be placed in a packaging, such as packaging 62, such that the packaging may direct the RF radiation to at least a portion of the RF circuitry.

FIG. 10 is a cut away perspective view of an optical article, such as an ID card 108, having an optical data layer 110 disposed on a substrate 112. The ID card 108 also includes a capping layer 114. As with capping layer 40 (FIG. 4), the capping layer 114 may chemically and mechanically protect the optical data layer 110. RF circuitry 116 is disposed on and coupled to a surface 118 of the capping layer 114 as illustrated. The RF circuitry 116 is coupled to the capping layer 114 by employing a optical-state change material (not shown), such as, for example, a pH sensitive organic dye and a thermally responsive material, which is responsive to the thermal energy produced by the RF circuitry 116 upon interaction with RF radiation. The acidity of the optical-state change material is altered upon interaction with the thermal energy. Accordingly, during authorization, when the RF circuitry 116 interacts with the RF radiation, the dye changes it optical absorbance, for example from optically opaque to an optically transparent state. In the pre-activated state of the ID card 108, the dye may inhibit the incident laser from reaching the optical data layer 110 by absorbing the incident laser. Whereas in the activated state the dye may become transparent to the incident laser, thereby enabling the incident laser to reach the optical data layer 110 and read the data stored in the optical data layer 110.

With reference to FIG. 11, a method of changing the functionality of the optical article, such as optical storage medium 120, is illustrated. Although the illustrated method is with regard to optical storage medium 120, it should be appreciated that this method may be employed to change the functionality of other optical articles, such as an ID card, a payment card, a personal information card, etc. The optical storage medium 120 includes a data storage region 122 and a non-data storage region or inner hub 124. The optical storage medium 120 further includes RF circuitry 126 disposed on and coupled to the optical storage medium 120. The optical storage medium 120 may include a optical-state change material (not shown), such as a thermochromic dye or an adhesive disposed between the RF circuitry 126 and the optical storage medium 120. The optical-state change material may alter the state of functionality of the optical storage medium 120 as described above with regard to FIGS. 8-10. The method includes employing RF radiation 128 to interact with the RF circuitry 126. During authorization, the RF circuitry 126 produces thermal energy by interacting with the RF radiation 128. This thermal energy then reacts with the optical-state change material and alters an optical property of the optical-state change material to provide a readable optical storage medium 120. Following authorization, the RF circuitry 126 is rendered into a detachable form of RF circuitry 126′. The detachable form of RF circuitry 126′ may be detached either just after authorization, or may be detached later by the user prior to employing the optical storage medium in a device, such as a player.

FIG. 12 illustrates an embodiment of an optical storage medium 140 employing a layer 130 of a thermally responsive optical-state change material layer, which is coupled to an RF circuitry 142. The RF circuitry 142 further includes an antenna 144, which is connected to a Nichrome wire 148. In turn, the Nichrome wire 148 is coupled to the layer 130. The Nichrome wire 148 may act as a heater to provide heat to the thermochromic material of the layer 130, the thermochromic material upon reaction with the heat may change color, thereby altering the state of functionality of the optical storage medium 140. The Nichrome wire 148 may be coupled to the anode of the RF circuitry 142. The RF circuitry 142 may optionally include a capacitor. In these embodiments, the antenna 144 may be exposed to the external electric field to charge the capacitor. Subsequently, the capacitor may be discharged to transfer the current to the Nichrome wire 148, thereby heating the Nichrome wire 148. 132, 134, 136 and 140 are the optical data layer, substrate, capping layer and inner hub respectively.

FIG. 13 illustrates a method for preventing unauthorized activation attempts of an optical storage medium 150. The method may be applied for other optical articles, such as an ID card, a payment card, a personal information card, and the like. As illustrated, the optical storage medium 150 includes a data storage region 154 having one kind of optical-state change material disposed in discrete portions 152. The optical storage medium 150 also has an inner hub 156. In pre-activated state, the optical storage medium 150 does not play, that is, the data in the optical data layer (not shown) of the optical storage medium 150 is unreadable. However, when interacted with an authorized external stimulus 164, the optical-state change material alters the functionality of the optical storage medium 150 (activated state) as described above and renders it to a playable state 158. When attempts are made to activate the optical storage medium 150 using an unauthorized external stimulus 166, for example, some one stealing the optical storage medium 150 and using a thermal energy source to activate the optical storage medium 150, the second optical state-change material 160 changes it optical absorbance and irreversibly converts the optical storage medium to an unplayable state 162.

FIG. 14 illustrates another method of preventing unauthorized activation. The optical article 170 includes at least two optical-state change material regions 174 and 176 which are in direct physical contact with each other, (i.e., juxtaposed next to each other). In this illustration the first optical-state change material 174 having an optical absorbance greater than about 450 nm in the “pre-activated” state 171, and the second optical-state change material 176 having an optical absorbance less than about 450 nm in the “pre-activated” state 171. Upon authorized activation 178, the optical article is converted to the “activated” state 186 where the optical properties of only the first optical-state change material is transformed 180 such that the optical absorbance is less than about 450 nm. Upon unauthorized activation 182, the optical article is converted to a “damaged” state 185 where the optical absorbance of the first optical-state change material is transformed 180 such that the optical absorbance is less than about 450 nm and the optical absorbance of the second optical-state change material is transformed 184 such that the optical absorbance is greater than about 450 nm

### EXAMPLE 1

Samples 1-8 were prepared as follows: Stock solutions were prepared in 4 dram vials according to the formulations described in Table 1. Polymethylmethacrylate with an Mw of 350K (PMMA, Aldrich, CAS 9011-14-7) was first dissolved in either pure di(propyleneglycol)methylether (DPM, Aldrich, CAS 108-94-1 ) or a 70:30 mixture of DPM and diacetone alcohol (DAA, Aldrich, CAS 123-43-2). To the mixture was added bromocresol green dye (BCG, 3′3″5′5″-tetrabromo-m-cresolsulfonephthalein sodium salt, Aldrich, CAS 76-60-8), a thermally latent acid salt (XC-7231, available from King Industries, CAS proprietary), and a small amount of piperidine (Aldrich, CAS 110-89-4) to adjust the pH of the stock to >7. The mixture was dark blue in color. A small aliquot (˜50 mg) of each stock was spin coated on commercial DVD-5 discs (1000 rpm for 10 seconds), to produce films approximately 5-10 microns thick, and the films were dried at 60° C. in air for 15 minutes. The percent reflectivity of the film, at 650 nm, was measured using a fiber optic UV-Vis spectrometer (Ocean Optics Inc.). The DVD-5 discs were then placed on top of a pre-heated hotplate, set to 130° C., and heated in air for 60 seconds during which time the dark blue film turned yellow. The percent reflectivity of the yellow film, at 650 nm, was measured using the same fiber optic UV-Vis spectrometer. The recorded percent reflectivity values before and after heating are listed in Table 1.

TABLE 1

| | Mass (mg) | | | | | | % Reflectivity | |
|---|---|---|---|---|---|---|---|---|
| Sam- | | | | | XC- | Piperi- | Before | After |
| ple | PMMA | BCG | DPM | DAA | 7231 | dine | Heating | Heating |
| 1 | 700 | 100 | 9200 | — | 113 | 20 | 30 | 92 |
| 2 | 900 | 100 | 9000 | — | 100 | 19 | 11 | 82 |
| 3 | 700 | 150 | 9150 | — | 147 | 20 | 23 | 93 |
| 4 | 900 | 150 | 8950 | — | 154 | 19 | 11 | 84 |
| 5 | 700 | 100 | 6440 | 2760 | 103 | 23 | 35 | 94 |
| 6 | 900 | 100 | 6300 | 2700 | 114 | 22 | 18 | 94 |
| 7 | 700 | 150 | 6405 | 2745 | 159 | 21 | 20 | 93 |
| 8 | 900 | 150 | 6265 | 2685 | 151 | 22 | 14 | 92 |

### EXAMPLE 2

Naphthol Blue Black (NBB, Aldrich, CAS 1064-48-8) was protected with a tert-butoxycarbonyl group (t-Boc, Aldrich, CAS 2442-99-5) according to a procedure described in Chem. Eur. J. 2000, 6(21), 3984-3990. Accordingly, a 100 ml round bottom flask was charged with 308 mg of NBB (0.5 mmol), 3.2 mg of dimethylaminopyridine (DMAP, Aldrich, CAS 1122-58-3), 450 mg of t-Boc, and 6 mL of dimethylformamide (DMF, Aldrich, CAS 68-12-2). The deep blue solution was stirred under nitrogen at 118° C. for 12 hours, during which time it turned to a golden yellow homogenous solution. The volatiles were removed under vacuum, and the solid yellow product (t-Boc-NBB) was recrystallized from warm DMF, and dried under high vacuum at 50° C. for 24 hours. 10 mg of the t-Boc-NBB was dissolved in 1 g of poly(ethyleneglycol)di-acrylate monomer (SR610, Sartomer Company, CAS 26570489) along with 10 mg of p-toluenesulfonic acid (PTSA, Aldrich, CAS 104-15-4), and 20 mg of a radical initiator (Darocur 1173, Ciba Specialty Chemicals, CAS 7473-98-5). The mixture was stirred until it became homogenous, and a spot (˜50 mg) of the pale yellow acrylate solution was deposited on a DVD-5 disc and cured for 2 seconds using a UV flash lamp (Xenon Corp, 300 W/cm²). The DVD-5 disc was placed on top of a pre-heated hotplate, set to 130° C., and heated in air for 60 seconds during which time the dark blue spot turned yellow.

### EXAMPLE 3

A blue film containing 7% polymethylmethacrylate with a Mw of 1 MM (PMMA, Aldrich, CAS 9011-14-7), 0.5% bromocresol green dye (BCG, 3′3″5″5″-tetrabromo-m-cresolsulfonephthalein sodium salt, Aldrich, CAS 76-60-8), and 1% of a thermally latent acid salt (XC-7231, available from King Industries, CAS proprietary) in DPM:cylohexanone (95:5) (DPM, Aldrich, CAS 34590-94-8; cyclohexanone, Aldrich, CAS 108-94-1) was screen printed onto the surface of a DVD-5. The thickness of the film was ˜1 μm. A 75-ohm 2512 chip resistor was placed in contact with the film and secured with transparent polyimide tape. The film was heated by applying a voltage (8 V, 3 min) to the resistor and a transition in film color from blue to yellow was observed. The percent reflectivity was measured before and after heating using an Ocean Optics USB2000 fiber optic spectrometer the results of which are graphically represented FIG. 15. As shown in FIG. 15, the percent reflectivity of a screen-printed film change from a initial value 200 before heating to a value 202 after heating. The change in reflectivity at 615 nm and 650 nm was 20.3% and 15.5%, respectively.

### EXAMPLE 4

Samples 4a-4f were prepared as follows: Stock solutions were prepared by dissolving the dyes listed in Table 2 in N-methyl-2-pyrrolidinone at 10 weight percent. A stock solution of the thermally-latent acid salt (XC-7231, available from King Industries, CAS proprietary) was prepared by dissolving it in N-methyl-2-pyrrolidinone at 10 weight percent. An acrylate stock solution was prepared by dissolving 90 g polyethylene glycol diacrylate (Sartomer SR610), 10 g trimethylolpropane triacrylate (Sartomer SR351), and Ig Irgacure 819 (Ciba) photo initiator. Individual dye solutions were then prepared by mixing 200 mg of the dye stock solution, 200 mg of the thermally latent acid stock solution and 1.6 g of the acrylate stock solution. About 5 mg of ammonium hydroxide were added to each solution to adjust the pH. About 10 μL of each dye solution were then deposited onto a DVD and exposed to 3 seconds of a UV flash lamp (Xenon Corp, 300 W/cm2) to cure. The color of the solutions and cured films are shown in Table 2. The percent reflectivities of the cured films, at 650 nm, were measured using a fiber optic UV-Vis spectrometer (Ocean Optics Inc.). Note that the reflectivity of an uncoated portion of the DVD was also measured and used as a baseline. The DVD was then placed on top of a pre-heated hotplate, set to 130° C., and heated in air for 3 minutes during which time the color of the films changed. The color and percent reflectivities (% R) of the films before and after heating are shown in Table 2.

TABLE 2

| | | | Color of | color after heating |
|---|---|---|---|---|
| | | color of | film after | at 130° C. |
| Sample | Dye | solution | UV cure | for 3 min |
| 4a | crystal violet | colorless | colorless | blue |
| | lactone | | (100% R) | (11% R) |
| 4b | benzoyl leuco | colorless | very light | blue |
| | methylene blue | | blue | |
| 4c | thymol blue | blue | red | yellow |
| 4d | thymolphthalein | blue | colorless | yellow |
| 4e | bromocresol | blue | blue | yellow |
| | purple | | (14% R) | (100% R) |
| 4f | bromocresol | blue | blue | yellow |
| | green | | (8% R) | (83% R) |

### EXAMPLE 6

A portion of a DVD-5 disc, located approximately 24 mm from the center hub of the disc, was screen printed with a thin layer of blue thermochromic material with a maximum optical absorbance in the range of 600-650 nm. The resulting dark blue thermochromic layer was approximately 1 mm (w)×6 mm (1)×0.5 μm (h) in size, and was prepared according to the following procedure: a stock solution of polymethylmethacrylate with an Mw of 1 MM (PPMA, Aldrich, CAS 9011-14-7) and di(propyleneglycol)methylether (DPM, Aldrich, CAS 34590-94-8) was first prepared by dissolving 4.55 g of PMMA into 45.53 g of DPM, and stirring over a 2 day period at 70° C. A 5.1 g aliquot of this stock was then mixed with 5.0 g of a 70:30 mixture of DPM and diacetone alcohol (DAA, Aldrich, CAS 123-43-2). To the mixture was added 155.4 mg of bromocresol green dye (BCG, 3″3″5′5″-tetrabromo-m-cresolsulfonephthalein sodium salt, Aldrich, CAS 76-60-8), 100.8 mg of a thermally latent acid salt (XC-7231, available from King Industries, CAS proprietary), and 22 mg of piperidine (Aldrich, CAS 110-89-4) to adjust the pH to >7. The mixture was dark blue in color. The dark blue solution was stirred for 48 hours in the dark at ambient temperature and was filtered through a 0.45 μm filter immediately prior to screen-printing. The percent reflectivity, at 650 nm, of the dark blue thermochromic layer was measured using a fiber optic UV-Visible spectrometer (Ocean Optics Inc.) and is reported in Table 2. The optical article comprising the dark blue optical-state material (i.e., the dark blue thermochromic layer) was then exposed to a 13.56 MHz RF source, which was transferred from a fixed transmitting device to a standard, commercially available, 0805 50 ohm chip resistor in physical contact with the optical state change material (e.g. the resistive heating element) by inductive coupling at 13.56 MHz between two coils arranged near one another about 0.25 inches apart. The two coils acted as a resonant air-core radio frequency transformer, and for laboratory test purposes, the receiving coil was a commercially available RFID antenna. To efficiently transfer a significant amount of power to the chip resistor model, both the primary and the secondary coils of the air-core RF transformer were matched with two capacitors chosen to cancel the transformer reactance and to match the resistance to approximately 50 ohms for the convenience of measurement. Many matching circuits could be used for this purpose, but a tapped capacitor was selected as requiring the least space in final implementation. Additional inductors often used in matching circuits were specifically avoided to minimize space. The inherent inductance of the transformer coils was used for the inductors required in the matching network. A thermocouple was placed on top of the heater and connected to a Mastech MS345 digital multimeter (Precision Mastech Enterprises Co., Hong Kong). RF energy of frequency 13.56 MHz was applied to the resistive heating element at varying powers and for various times. The temperature of the resistive heating element was recorded (cf. Table 3). The percent reflectivity, at 650 nm, of the optical state change material was recorded after heating using a fiber optic UV-Vis spectrometer (Ocean Optics Inc.) and is reported in Table 3.

TABLE 3

| | RF power | | Temperature | | % Reflectivity | |
|---|---|---|---|---|---|---|
| | delivered to | | (° C.) | | Before | After |
| Sample | microheater (W) | Time (s) | Initial | Final | Heating | Heating |
| 1 | 0.39 | 180 | 27 | 106 | 34.4 | 68.7 |
| 2 | 0.35 | 300 | 27 | 87 | 37.2 | 68.7 |

### EXAMPLE 7

A DVD is prepared that has a thermochromic coating near the table-of-contents region of the data layer. The thermochromic coating is initially colored blue and significantly absorbs 650 nm laser light. The DVD is placed in a DVD player but does not play. A similar DVD is prepared that also has the thermochromic layer. This DVD, in its case, is exposed at point-of-sale to a 5 W, 13.56 MHz RF source that induces an electrical current in the antenna. The current powers the microheater and a local temperature of about 130° C. is achieved in the thermochromic coating. The heat causes acid to liberate from a thermal acid generator (a sulfonic acid ester). The acid causes a pH-sensitive dye (e.g. bromothymol blue) to turn from blue-colored to yellow. The DVD is removed from its case and placed in a DVD player. The DVD boots-up and is easily read by a drive with no loss of data.

While the invention has been described in detail in connection with only a limited number of embodiments, it should be readily understood that the invention is not limited to such disclosed embodiments. Rather, the invention can be modified to incorporate any number of variations, alterations, substitutions or equivalent arrangements not heretofore described, but which are commensurate with the spirit and scope of the invention. Additionally, while various embodiments of the invention have been described, it is to be understood that aspects of the invention may include some of the described embodiments. Accordingly, the invention is not to be seen as limited by the foregoing description, but is only limited by the scope of the appended claims.

What is claimed as new and desired to be protected by Letters Patent of the United States is:

1. An optical article transformable from a pre-activated state of functionality to an activated state of functionality, said optical article comprising:
an optical data layer for storing data; and
a thermally responsive optical-state change material having optical absorbance in the range of 200 nm to 800 nm and being capable of transforming the optical article from the pre-activated state of functionality to the activated state of functionality upon exposure to an external stimulus.

2. The optical article of claim 1 wherein transformation from the pre-activated state of functionality to the activated state of functionality is irreversible.

3. The optical article of claim 1, wherein said thermally responsive optical-state change material comprises a thermochromic material, dye, thermally responsive compound, or combinations thereof.

4. The optical article of claim 3, wherein said optical-state change material is encapsulated inside a temperature sensitive coating material.

5. The optical article of claim 4, wherein the temperature sensitive coating material is a wax, an oil, a polymeric material or any combination thereof.

6. The optical article of claim 3, wherein the thermally responsive compound is a super acid salt.

7. The optical article of claim 3, wherein the dye material comprises a thermally labile protecting group.

8. The optical article of claim 7, wherein the thermally labile protecting group is an acid labile protecting group, or a base labile protecting group.

9. The optical article of claim 8, wherein the thermally labile protecting group comprises a carbonyl group, a silyl group, a sulfonate group, an organic group containing at least 4 carbon atoms or combinations thereof.

10. The optical article of claim 3, wherein the dye material is a pH responsive dye material.

11. The optical article of claim 3,wherein the pH responsive dye material comprises at least one member selected from the group consisting of bromocresol green, bromocresol purple, bromophenol blue, bromothymol blue, congo red, crystal violet, methyl green, thymolphthalein, thymol blue, or any salts thereof.

12. The optical article of claim 1, wherein the external stimulus changes the acidity of the optical-state change material.

13. The optical article of claim 3, wherein the thermally responsive optical-state change material is capable of thermally-induced change in bond connectivity, oxidation state, or a combination thereof.

14. The optical article of claim 1, wherein said optical-state change material transforms the optical article from the pre-activated state of functionality to an activated state of functionality in a temperature range from about 25° C. to about 200° C.

15. The optical article of claim 1, wherein the external stimulus comprises a laser, thermal energy, electromagnetic radiation, gamma rays, acoustic waves, electrical energy, chemical energy, magnetic energy, mechanical energy, radio frequency waves, ultraviolet radiation, or combinations thereof.

16. The optical article of claim 1, wherein said optical-state change material is disposed in a discrete area of the optical article, a continuous layer extending across a portion of the optical article, or a patterned layer extending across a portion of the optical article.

17. The optical article of claim 1, wherein said pre-activated state is characterized by an optical reflectivity of at least a portion of the optical article being less than about 45 percent optical reflectivity and said activated state is characterized by an optical reflectivity of at least a portion of the optical article being more than about 45 percent optical reflectivity.

18. The optical article of claim 1 wherein a change in optical reflectivity of at least 10 percent is observed after transformation from the pre-activated state of functionality to the activated state of functionality.

19. The optical article of claim 1, wherein said optical article comprises one of a CD, a DVD, a HD-DVD, a Blu-ray disc, a near field optical storage disc, a holographic storage medium, an identification card, a passport, a payment card, a driving license, or a personal information card.

20. The optical article of claim 1, further comprising a packaging for the optical article, wherein said packaging enables an external stimulus to be directed toward at least a portion of said optical article.

21. The optical article of claim 20, wherein said packaging comprises a window aligned with at least a portion of said optical article.

22. The optical article of claim 1, further comprising a wirelessly powered flexible tag, wherein the tag is operatively coupled to the optical article.

23. The optical article of claim 22, wherein said tag is configured to interact with said external stimulus.

24. The optical article of claim 22, wherein said tag is a multicomponent structure.

25. The optical article of claim 22, wherein said tag comprises an adhesive coupling layer.

26. The optical article of claim 25, wherein said adhesive coupling layer comprises a pressure-sensitive adhesive, a water soluble adhesive, an acrylate-based adhesive, a silicone-based adhesive, an elastomer-based adhesive, an epoxy-based adhesive, a thermoset adhesive, an acrylate-based adhesive, or any combination thereof.

27. The optical article of claim 25, wherein said adhesive coupling layer comprises a patterned surface.

28. The optical article of claim 22, wherein said tag further comprises electrical circuitry.

29. The optical article of claim 28, wherein said electrical circuitry comprises radio frequency circuitry.

30. The optical article of claim 28, wherein said electrical circuitry further comprises a thermocouple, a light-emitting diode, a strain gauge, a sound detecting element, a diode, an antenna, a dipole, an electrical receiver, a photocell, a resistor, a capacitor, a rectifier, an integrated circuit, a surface mount resistor, a chip resistor, a transistor, an electrode, a heating element, or any combination or multiple thereof.

31. The optical article of claim 30, wherein said heating element comprises titanium, copper, nickel, gold, tantalum-nitride, aluminum, molybdenum, titanium-tungsten, chrome, platinum, nichrome, indium tin oxide and any combinations or alloys thereof.

32. The optical article of claim 30, where in the heating element comprise of thick film resistor, thin film resistor or combinations thereof.

33. A method for changing a functionality of an optical article, comprising:
exposing an optical article to an external stimulus, the optical article comprising:
an optical data layer for storing data; and
a thermally responsive optical-state change material having optical absorbance in the range of 200 nm to 800 nm and being capable of transforming the optical article from a pre-activated state of functionality to an activated state of functionality upon exposure to an external stimulus.

34. The method of claim 33, wherein said optical-state change material comprises a thermochromic material, dye, thermally sensitive compound, or combinations thereof.

35. The method of claim 33, comprise a means for rendering the optical article un-readable upon unauthorized activation.

36. The method of claim 35, wherein said means comprise of plurality of thermally responsive optical-state change material working cooperatively.

37. The method of claim 36, wherein said optical-state change material is disposed in a discrete area of the optical article, a continuous layer extending across a portion of the optical article, or a patterned layer extending across a portion of the optical article.

38. The method of claim 36, wherein said optical-state change material is disposed so as to superimpose at least part of the data layer

39. The method of claim 33, where in said external stimulus comprises a laser, thermal energy, electromagnetic radiation, gamma rays, acoustic waves, electrical energy, chemical energy, magnetic energy, mechanical energy, radio frequency waves, ultraviolet radiation or combinations thereof.

40. The method of claim 33, wherein the optical article comprises a wirelessly powered flexible tag, operatively coupled to the optical article.

41. The method of claim 33, wherein said optical article comprises one of a CD, a DVD, a HD-DVD, a Blu-ray disc, a near field optical storage disc, a holographic storage medium, an identification card, a passport, a payment card, a driving license, or a personal information card.

42. A thermal activation system for transforming an optical article from a pre-activated state of functionality to an activated state of functionality, comprising:
a optical article to be activated;
an activation device for applying a thermal stimulus to the optical article to effect a change in optical absorbance of the optical article and thereby activate the optical article; and
a communication device for providing an activation signal to the activation device to permit activation of the optical article.

43. The system of claim 42, wherein said optical article comprise a thermally responsive optical-state change material having optical absorbance in the range of 200 nm to 800 nm.

44. The system of claim 42, wherein said optical-state change material comprises a thermochromic material, dye, thermally sensitive compound, or combinations thereof.

45. The system of claim 42, wherein the activation device comprises a wirelessly powered flexible tag, operatively coupled to the optical article.

46. The system of claim 45, wherein said tag is a multicomponent structure.

47. The system of claim 45, wherein the said tag comprises a radio frequency circuitry, a thermocouple, a light-emitting diode, a strain gauge, a sound detecting element, a diode, an antenna, a dipole, an electrical receiver, a photocell, a resistor, a capacitor, a rectifier, an integrated circuit, a surface mount resistor, a chip resistor, an electrode, a heating element, or any combination or multiple thereof.

48. The system of claim 45, where in the tag is removably coupled to the optical article.

49. The system of claim 42, where in the communication device comprise a reader disposed outside optical article and configured to communicatively interact with the activation device.

50. The system of claim 42, wherein the external stimulus comprises a laser, thermal energy, electromagnetic radiation, gamma rays, acoustic waves, electrical energy, chemical energy, magnetic energy, mechanical energy, radio frequency waves, ultraviolet radiation or combinations thereof.

51. The system of claim 42, wherein said optical article comprises one of a CD, a DVD, a HD-DVD, a blu-ray disc, a near field optical storage disc, a holographic storage medium, an identification card, a passport, a payment card, a driving license, or a personal information card.

52. The system of claim 42, further comprise a packaging for the optical article, wherein said packaging enables an external stimulus to be directed toward at least a portion of said optical article.

53. The system of claim 52, wherein said packaging comprises a window aligned with at least a portion of said optical article.
